(19) United States
(12) Patent Application Publication
(10) Pub. No.: US 2019/0032828 A1
(43) Pub. Date: Jan. 31, 2019

(54) LOCKING APPARATUS FOR THREADED COMPONENT CONNECTIONS

(71) Applicant: STONEAGE, INC., Durango, CO (US)

(72) Inventors: Gerald P. Zink, Durango, CO (US); Colton Andersen, Durango, CO (US); Cody R. Montoya, Aztec, NM (US); Jeffery R. Barnes, Ignacio, CO (US); Corey S. Waller, Durango, CO (US); Cooper Hanley, Durango, CO (US)

(21) Appl. No.: 16/045,140

(22) Filed: Jul. 25, 2018

Related U.S. Application Data
(60) Provisional application No. 62/539,328, filed on Jul. 31, 2017.

(51) Int. Cl. F16L 37/086

(52) U.S. Cl. CPC F16L 37/086

(57) ABSTRACT

Embodiments of a threaded component locking apparatus for preventing inadvertent disconnection of the male and female connection are disclosed. One embodiment includes an annular groove around the male member spaced from its threads and a ring shaped retainer disposed in the annular groove. A rear lip on the female threaded component interferes with the ring shaped retainer to prevent loosened connection between the components from becoming completely disconnected. Another embodiment utilizes a C-clip retainer member to limit loosening of the connection. Another embodiment utilizes a canted spring ring to interfere with and limit loosening of the connection. Another embodiment has a pair of collar halves that fit around the male member each having an annular groove for receiving a canted spring ring or ring shaped retainer to interfere with a rear lip on the female threaded component to limit loosening of the connection.

### CROSS REFERENCE TO RELATED APPLICATIONS

This application claims the benefit of priority of U.S. Provisional Patent Application No. 62/539,328 filed Jul. 31, 2017 entitled Locking Apparatus for Threaded Component Connections, the content of which is incorporated herein by reference in its entirety.

### BACKGROUND OF THE DISCLOSURE

There are many thread locking mechanisms that exist, which include double nuts, Lock-tite®, Nylok® nuts, lock washers, etc. These mechanisms inhibit loosening of threaded components on threaded shafts or tubes due to vibration, heat cycles or other causes. Many of these are either designed for one time use, or used only for specific applications.

Conventional rotary waterblasting nozzles such as StoneAge's Banshee® nozzles have a rotatable water bearing tubular shaft captured between an externally threaded inlet nut and a generally cylindrical body having an internally threaded rear end. External flats on both the body and the inlet nut are each designed to receive a wrench in order to tighten the inlet nut to the body in a conventional manner. The inlet nut is threadably joined to a high pressure hose in a conventional manner.

The water bearing tubular shaft, captured within the body, has a threaded distal end which extends out of a front end of the cylindrical nozzle body. This threaded end also has flats adjacent to the threads to receive an appropriately sized wrench. A spray head with internal threads is typically threaded onto this distal end. Likewise, the spray head has external flats to receive another appropriately sized wrench. The nozzle head and shaft are tightened to a manufacturer specified torque by turning the components relative to one another in a tightening direction. In the case of StoneAge's Banshee nozzles, the heads are designed to rotate in a direction further tightening the threaded joint between the nozzle head and rotating water bearing nozzle shaft.

These threaded connections, if properly made, do not come undone during foreseeable operation. However, in order to improve safety of operation of such high pressure fluid lines and nozzles there is a need for a secondary mechanical thread locking apparatus for use in such a connection to act as a second back-up mechanism to inhibit the tool, such as the nozzle head on rotary nozzles, from loosening during normal and abnormal tool operation, provide a warning of loosened connections and/or prevent unintended disconnection. This may provide an increased safety margin for the operator using such a rotary nozzle tool and other high pressure fluid connected component structures.

### SUMMARY OF THE DISCLOSURE

One embodiment in accordance with the present disclosure addresses this problem by utilizing a mechanical locking apparatus that may be installed on an existing male threaded component end without modification of the male threaded component. A modification is necessary of the female threaded component in order to receive the locking mechanism in accordance with this embodiment of the present disclosure. The apparatus provides substantial resistive force against counter-rotation of threaded components and may be used and re-used multiple times and in a variety of different applications.

This exemplary first embodiment of a locking apparatus for use between a female threaded component having parallel external wrench flats and a male threaded component having parallel external wrench flats in accordance with the present disclosure has three basic components: a pair of split annular collar halves and an annular spring member. Each half collar or collar half has a general “C” shape with an outer flange portion having at least two parallel external wrench flats, an annular outer groove portion, and two parallel internal flats radially spaced from and aligned with the external wrench flats. These internal flats are spaced complementary to wrench flats of a male threaded component such that the internal flats fit over and against the male threaded component wrench flats when the pair of collar halves are installed or mated on the male threaded component. The annular spring member is sized to elastically fit like a band into the outer groove portions of the split collar halves when the pair of halves are installed onto and over the wrench flats of the male threaded component, and thus hold the halves together on the male threaded component.

The female threaded component has threads which engage the threaded end of the male component. The female threaded component is formed with a skirt portion that fits over the groove portions of the split collar halves when the threaded components are threaded together. The skirt portion has an internal annular groove within the skirt portion for receiving an annular outer portion of the annular spring member when the components are threaded together.

In one example of this first embodiment, the annular spring member may be a canted coil spring ring. The cant, or lay of the coils of the spring member, is opposite the direction of tightening the components together when the spring is placed over the split annular collar halves and into the groove. Thus when the components are tightened together, the coils of the spring ring tend to further lie down. However, when the components are untightened, i.e. loosened, the coils of the spring ring tend to stand up, exerting a locking force against or inhibiting loosening of the connected male and female component connection.

Another example of the annular spring member may be a spring steel band that has outwardly projecting portions and oppositely inwardly projecting portions formed by closed slits in the band. These projecting portions lie slanted in the tightening direction in the collar groove such that they deflect as the components are tightened. However, when the components are untightened, i.e. loosened, the projecting portions tend to bend further outward in opposition to untightening rotation, again exerting a locking force inhibiting loosening of the connected male and female component connection.

An exemplary implementation of a locking apparatus in accordance with the present disclosure may be utilized in a self-balancing rotating nozzle assembly. This assembly includes a hollow cylindrical housing body having an inner surface, an inlet end, an outlet end, and a fluid inlet passage near the inlet end. A hollow shaft member is rotatably mounted coaxially within the housing body having a fluid inlet end near the inlet end of the housing body and an outlet end of the hollow shaft member having external male threads and a pair of parallel wrench flats extending out of the housing body. The shaft has a central passage for axially conducting fluid from said inlet end of the housing axially from and through the inlet end of the shaft to said outlet end of the shaft. The shaft has a passage communicating between the central passage of the shaft and a pressure chamber, wherein pressure of the fluid within the pressure chamber at least in part acts axially upon said shaft to dynamically balance any axial force on said shaft resulting from fluid pressure acting upon said inlet end of said shaft. A spray head is attached to the outlet end of the hollow shaft member. This spray head has parallel external wrench flats and a female threaded skirt portion. The assembly also includes a locking apparatus between the spray head and the hollow shaft member operable to resist relative rotation of the spray head with respect to the hollow shaft in a loosening direction.

This embodiment of a locking apparatus includes a pair of split annular collar halves each half having an outer flange portion having at least two parallel external wrench flats, an annular outer groove portion, and two parallel internal flats radially spaced from the external wrench flats complementary to the wrench flats of the hollow shaft member outlet end. The internal flats in the collar halves fit over and against the hollow shaft member outlet wrench flats. An annular spring member in the outer groove portions of the split collar halves hold the collar halves together when installed onto and over the wrench flats of the hollow shaft member. The nozzle head has a skirt portion and an internal annular groove within the skirt portion for receiving an outer portion of the annular spring member when the head is threaded onto the hollow shaft member outlet end.

Another exemplary embodiment in accordance with the present disclosure requires a minor modification of the male threaded component. In this embodiment, a circular groove is machined or otherwise formed behind the threads on the distal end of the male component. A circular round wire spring clip ring is disposed in the groove. The rear or proximal end of the female component such as a nozzle head is configured with a corresponding internal annular groove adjacent the entrance to the female threads in the female component. This groove defines a lip at the rear end of the female component. As the male and female components are threaded together, the lip at the rear end of the female component will eventually approach the clip ring and compress the wire spring clip as it passes over it until the clip ring snaps into the mating female component groove. This groove in the female component is wide enough such that the threaded connection may thereafter be tightened in a conventional manner. Thread locking compound may be utilized on the mated threads in a normal manner.

In the event that the connection in this exemplary embodiment becomes loosened, the annular spring clip will engage the back angle of the lip at the rear of the female component adjacent the groove to inhibit disconnection of the two components. Furthermore, should loosening occur, there will likely be some fluid leakage out of the connection past the threads to provide to an operator indication that the connection is loose. The mated components may be completely disconnected, but substantially greater torque will be required to compress the wire spring clip within its groove in the male component and permit the rear end of the female component to pass over the compressed wire spring clip. The back angle of the lip adjacent the groove of the female component will determine how hard the female component is to remove from the male component.

Another embodiment in accordance with the present disclosure involves again having an annular groove in the male member behind the threads on the distal end of the male member. Instead of providing a complementary groove in the rear end of the female component, however, an off axis cross bore is drilled through the female component so as to intersect with the annular groove in the male member when the components are fully threadably mated. A roll pin is press fit into the cross bore and passes through the annular groove to prevent full disengagement of the mated connection components. Again, the annular groove in at least the male member is wide enough so that the components can be fully threaded together while at the same time permitting the roll pin to interfere with disengagement in the event that the threaded component connection becomes loosened. Again, some fluid leakage past the threads would be an indication to an operator of the loosened connection. In this embodiment, however, the roll pin must be pressed out of the cross bore in order to disconnect the male and female components.

A further embodiment of a male-female threaded connection locking apparatus in accordance with the present disclosure utilizes a conventional C-clip retaining ring. In this alternative embodiment, an annular groove is formed on the male component spaced adjacent its threaded distal end. An annular internal groove is cut inside the female component adjacent its rear end adjacent to the threaded portion. An L shaped portion of the rear end of the female component adjacent the groove on at least one side is removed to provide lateral access to the internal annular groove. Once the male and female components are threadably engaged, the C-clip retainer member is laterally installed around the male component into the male component groove. Again if the male-female connection becomes loosened, the connection is retained intact while some leakage will likely be present past the threads, which may provide an operator with positive indication of the loosened connection without complete disassembly of the connection. Complete disassembly requires lateral removal of the C-clip retainer member prior to fully disengaging the threaded components.

A still further embodiment is a configuration in which the male threaded component is fitted with a longer length of threads and an annular C clip retention groove is cut in the male threaded component spaced from the threaded portion that fastens the female component to the male component. Thus the male component will have a first threaded portion and a second threaded portion spaced from the first threaded portion by this retention groove. A threaded ring that has an external annular groove adjacent its distal end is first threaded over the first portion and onto the second portion of the male component threads and a C-clip retainer member is installed in the retention groove. The C-clip retains the threaded ring in place. A wire spring clip ring is placed in the external annular groove of the threaded ring. The female component is configured with an annular recess adjacent its rear end. The rear edge of this recess defines an annular lip at the rear end of the female component. As the female component is threaded onto the male component, this rear lip passes onto the threaded ring and engages passes over the wire spring clip ring. The wire spring clip ring then expands into the annular recess. The rear annular lip of the female component has a back angle which determines how difficult the female component will be to remove from the male component. The threaded ring has external wrench flats to facilitate installation and removal of the threaded ring from the male component and from the female component so that the C-clip may be removed.

A still further embodiment in accordance with the present disclosure, that does not require a modification to the male component, is a modification of the first embodiment described above. In this alternative, instead of an annular canted coil spring, a wire spring clip as in the second embodiment, described above and below, could be utilized to achieve the same result.

Additional embodiments are also described below. Further features, advantages and characteristics of the embodiments of this disclosure will be apparent from reading the following detailed description when taken in conjunction with the drawing figures.

### BRIEF DESCRIPTION OF THE DRAWING

FIG. 1 is a perspective exploded view of a nozzle assembly incorporating a locking apparatus in accordance with a first embodiment of the present disclosure.

FIG. 2 is a separate end perspective view of a first split collar half installed on the distal end of a rotatable nozzle shaft after the shaft has been assembled within the nozzle housing body in accordance with the present disclosure.

FIG. 3 is a separate end perspective view as in FIG. 2 with the second split collar half installed on the distal end of the rotatable nozzle shaft along with a canted bias spring ring in accordance with one embodiment of the present disclosure.

FIG. 4 is a is a partial perspective view of the assembled nozzle shown in FIG. 1 with the rotatable nozzle shaft tightened onto the nozzle head in accordance with the present disclosure.

FIG. 5 is a longitudinal cross sectional view through the nozzle in accordance with the present disclosure shown in FIG. 4.

FIG. 6 is a transverse cross sectional view through the nozzle taken along line 6-6 in FIG. 5

FIG. 7 is a transparent perspective view of a nozzle head locking embodiment of a threaded component locking apparatus in accordance with the present disclosure.

FIG. 8 is a longitudinal cross sectional view of the locking apparatus shown in FIG. 7.

FIG. 9 is a transparent perspective view of another embodiment of a head locking apparatus in accordance with the present disclosure.

FIG. 10 is a partially transparent perspective view of another embodiment of a locking apparatus in accordance with the present disclosure.

FIG. 11 is a transparent perspective view of another alternative embodiment of a head locking apparatus in accordance with the present disclosure.

FIG. 12 is a longitudinal cross sectional view of the threaded component locking apparatus shown in FIG. 11.

FIG. 13 is a longitudinal cross sectional view of another embodiment of a nozzle head locking apparatus in accordance with the present disclosure.

FIG. 14 is an enlarged view of a portion of the apparatus shown in FIG. 13.

FIG. 15 is an exploded perspective view of the embodiment shown in FIG. 13.

FIG. 16 is a separate perspective view of the locking spring band in the embodiment shown in FIG. 13.

FIG. 17 is an end view of the locking spring band shown in FIG. 16.

FIG. 18 is a separate side view of the release plunger shown in FIGS. 13 and 14.

FIG. 19 is a side view of a nozzle head utilized in another threaded component locking device in accordance with the present disclosure shown in FIG. 20.

FIG. 20 is a longitudinal sectional view a head locking device for a high pressure nozzle in accordance with the present disclosure utilizing the nozzle head shown in FIG. 19.

FIG. 21 is a perspective view of another head locking device installed on a nozzle head in accordance with the present disclosure.

### DETAILED DESCRIPTION

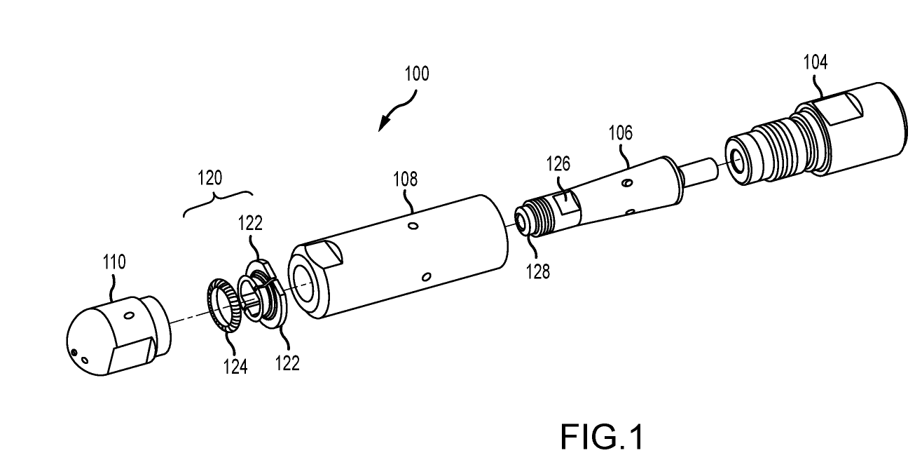

A first exemplary embodiment of a nozzle 100 incorporating one embodiment of a locking apparatus 120 in accordance with the present disclosure is shown in an exploded perspective view in FIG. 1. The nozzle 100 includes a conventional rotary nozzle inlet nut 104, male threaded rotary tubular shaft 106, a cylindrical nozzle housing 108, and a modified nozzle head 110. The housing 108 and inlet nut 104 are threaded together to capture the rotary nozzle shaft 106 therebetween such that the rotary tubular shaft 106 is free to rotate within the housing 108. A locking apparatus 120 comprising a pair of split collar halves 122 and a canted coil spring ring 124 are fastened onto and over the flats 126 on the male distal end 128 of the rotary shaft 106. The male threaded end 128 and part of the locking apparatus 120 fit into the modified nozzle head 110 as will be described in further detail below.

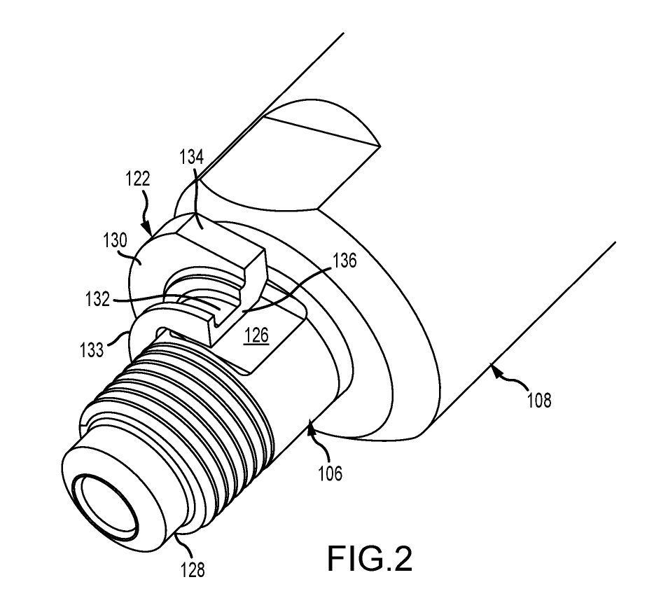

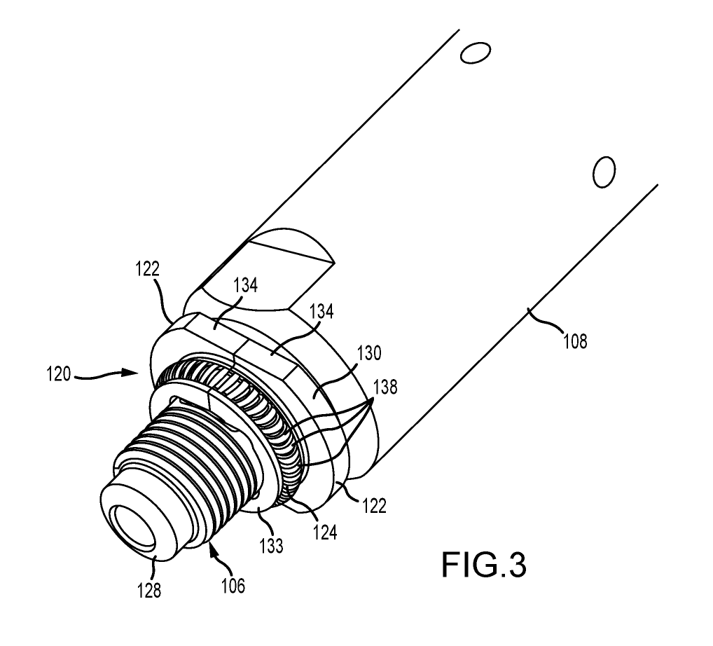

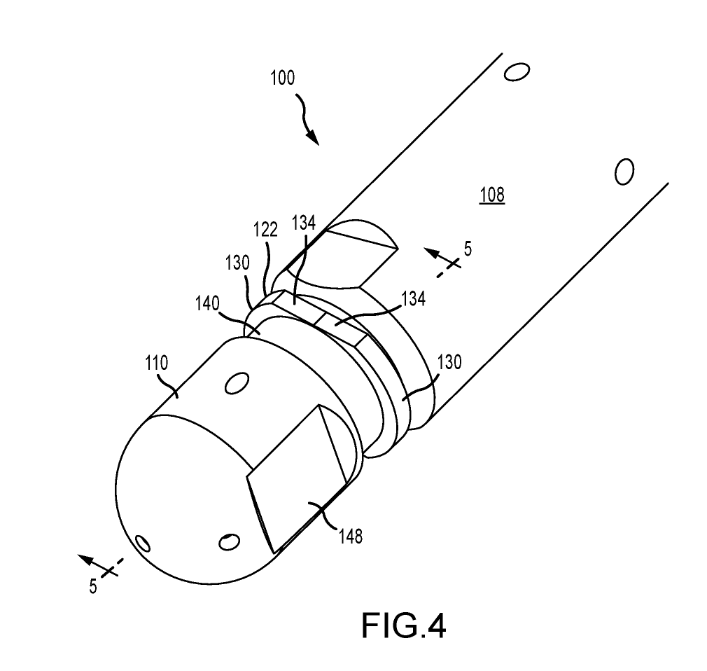

FIG. 2 shows one of the collar halves 122 installed on and over the flats 126 at the distal end 128 of the rotary shaft 106. FIG. 3 shows both the collar halves 122 installed over the flats 126 and captured on the distal end 128 via an annular canted coil spring 124. FIG. 4 shows a perspective view of the assembled nozzle 100 with the nozzle head 110 fully tightened onto the distal end 128 of the rotary shaft 106. FIG. 5 is a longitudinal sectional view of the assembled nozzle 100 taken along the line 5-5 in FIG. 4

Turning back now to FIG. 2, each of the collar halves 122 is a generally C shaped rigid solid body having an outer radial flange portion 130 and a groove portion 132. The flange portion 130 has a pair of diametrically opposite parallel outer wrench flats 134, only one of which is shown in FIG. 2. The collar half 122 also has a pair of diametrically opposite parallel internal flats 136 configured to match fit onto the wrench flats 126 on the distal end 128 of the rotary shaft 106. When the second collar half 122 is installed onto the distal end 128 of the rotary shaft 106, as shown in FIG. 3, the outer wrench flats 134 are fully exposed and serve to accommodate an appropriately sized wrench to tighten the modified spray head 110 onto the rotary shaft 106.

FIG. 3 shows the collar halves 122 installed on the distal end 128. An annular spring member 124 installed in the mated groove portions 132. This groove portion 132 of each of the collar halves 122 is sized so as to have a depth of slightly less than half the diameter of the coil turns of the annular coil spring member 124. The groove portions each have a lip 133 that retains the annular spring member 124 in the groove portions 132. The annular spring member 124 retains the collar halves 122 on the distal end 128 prior to assembly of the spray head 110 onto the shaft 106. As viewed in FIG. 3, the canted spring coils 138 lay canted in a clockwise direction about the axis of the shaft 106. When the head 110 is right hand threaded onto the distal end 128 of the rotary shaft 106, the coils will be further deflected in the same direction into the groove 132 as the head 110 rotates onto the shaft 106.

The head 110 fully installed on the rotary shaft 106 is shown in FIG. 4. The internal structure of the head 110 can be seen in the longitudinal sectional view of the nozzle 100 shown in FIG. 5. This modified spray head 110 is similar to a conventional nozzle spray head except that the head 110 includes an annular skirt 140 adjacent the female threaded portion 142. This skirt 140 has an internal annular groove 144 spaced from the threaded portion 142 and terminates at an annular ridge 146 at the distal end of the skirt 140.

During installation, the lip 133 of the collars 122 is passed beneath the annular ridge 146 of the skirt 140 of the head 110 as the distal end 128 of the shaft 106 is threaded into the head 110. The canted coils 138 of the spring 124 deflect under the annular ridge 146 and rebound outward into the annular groove 144 of the skirt 140 until the head 110 is fully installed on the distal end 128 of the shaft 106. The joint between the head 110 and shaft 106 can be tightened to a specific torque via suitable wrenches fitted to shaft flats 134 and head flats 148. In addition, conventional thread locking compounds such as a Locktite® formulation is preferably utilized on threads 142 in a conventional manner.

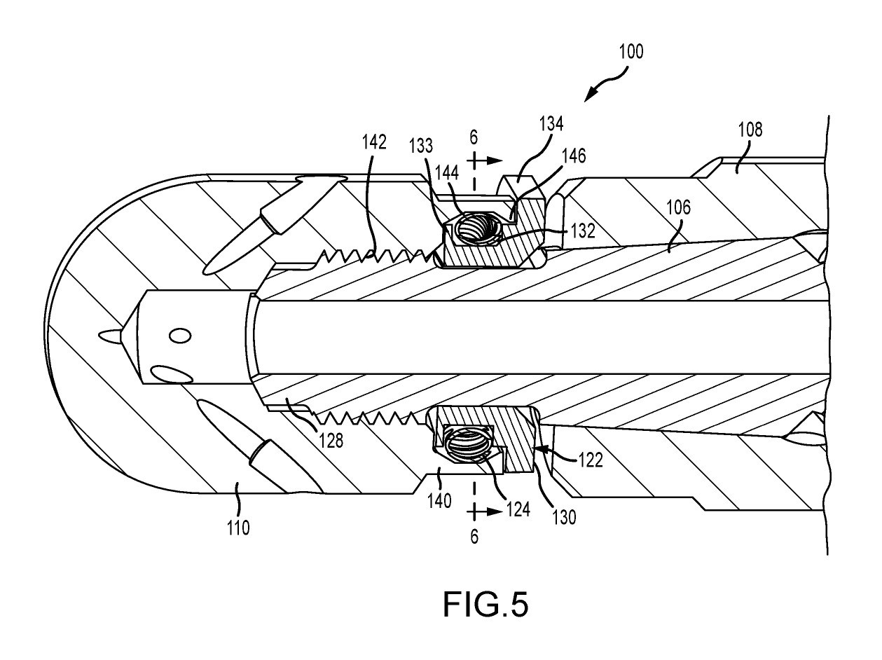

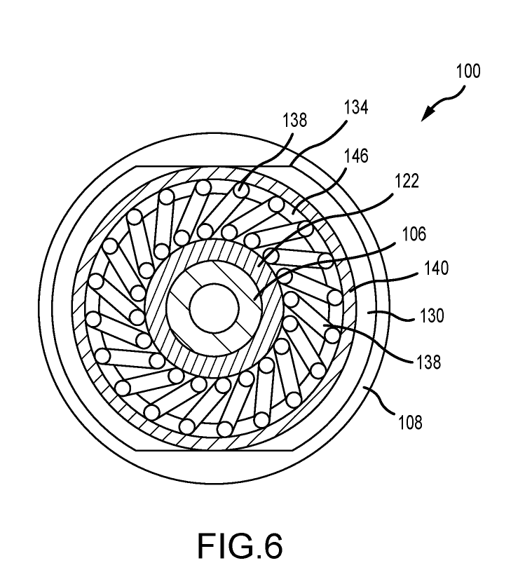

A transverse cross sectional view through the assembled nozzle 100 taken along the line 6-6 in FIG. 5 is shown in FIG. 6. The portions of coils 138 that are visible all cant in a clockwise direction. If and when a torque were to be applied between the shaft 106 and the head 110 in a counterclockwise direction, relative movement would cause the coils 138 to move counterclockwise as shown in FIG. 6, tending to stand up, This tends to increase resistance to relative movement hence provides a resistive force against loosening the connection.

An alternative annular spring ring may be formed from a sheet material into a ring. Rather than being a coil spring, the spring ring is a circular band made from a flat spring steel strip that has a series of blind slits along its length, that, when the strip is bent into a ring and heat treated generates alternating inwardly and outwardly directed prongs or projections around its circumference. When such a spring ring is utilized in place of the canted coil spring shown in the locking apparatus 120, these alternating prongs which all lay in a similar direction as the coils 138 would tend to stand up, engaging the skirt 140 and the bottom of the groove 132 to again inhibit loosening of the connection.

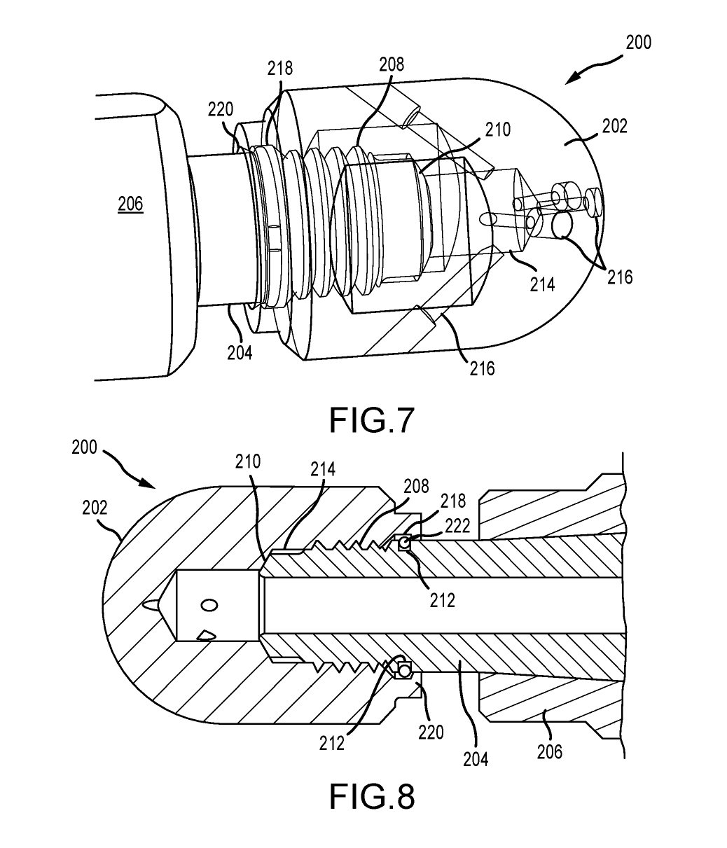

Another embodiment of a threaded component locking apparatus 200 in accordance with the present disclosure is shown in perspective view in FIG. 7 and sectioned in FIG. 8. In this embodiment 200, a female component, in this case a nozzle head 202, is attached to a male component, a rotatable tubular nozzle shaft 204, that is free to rotate in a nozzle body 206. The nozzle body 206 is, in turn, connected to a high pressure fluid hose (not shown). The male component, rotatable tubular nozzle shaft 204, has external threads 208 adjacent its distal end 210 and an annular groove 212 in the shaft 204 rearward of the threads 208. The nozzle head 202 has an internally threaded central blind bore 214 and a plurality of offset fluid passages 216 leading from the bore 214 out of the nozzle head 202 to, in part, impart rotation to the shaft 204 in operation.

The nozzle head 202 has an annular groove 218 adjacent its rear end forming an annular lip 220 spaced from the internal threads 208. When the shaft 204 and head 202 are fully threaded together, annular grooves 212 and 218 are axially and radially aligned. An annular wire spring clip 222 in the aligned grooves 212 and 218 locks the mated components 204 and 202 together. To assemble the apparatus 200, first the annular wire spring clip is installed within the groove 212 around the shaft 204. The nozzle head 202 is then threaded onto the shaft 204 until the distal end 210 of the shaft 204 is fully seated in the blind bore 214. As the head 202 is threaded onto the shaft 204, the lip 220 passes over the spring ring clip 222 in groove 212 and deflects or compresses the spring ring clip 222 further into the groove 212 to permit passage of the head 202 onto the shaft 204. When the distal end 210 of the shaft 204 is fully seated as shown, the grooves 212 and 218 are aligned, and the clip ring 222 partially expands within the complementary groove 218.

During operation, should a reverse torque somehow be applied to the threaded connection, in this case between the nozzle head 202 and shaft 204, sufficient to disengage shaft distal end 210 from its seat in the blind bore 214, the head 202 could conceivably rotate via threads 208 a short distance until the lip 220 encounters the spring ring clip 222. The head 202 is thus stopped or locked from being further loosened. If this event should happen, there will likely be some fluid leakage past the threads 208 such that an operator of the tool may notice an unusual leak rate, or if depressurized, he may notice the loose head 202 on the shaft 204. A significant further torque will be required to unlock the head 202, i.e., cause the lip 220 to compress the spring clip 222 sufficient to permit the head 202 to be unthreaded enough to pass by the spring clip 222 and completely remove the head 202 from the shaft 204.

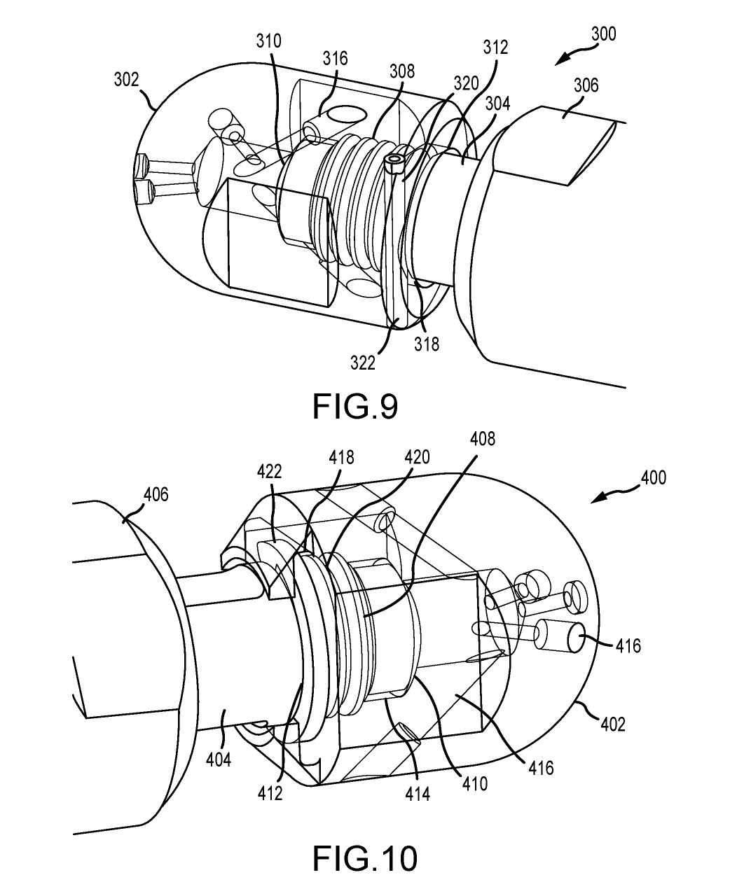

Referring now to FIG. 9, another exemplary embodiment of a threaded component locking apparatus 300 is shown. In this embodiment 300, a female component, in this case a nozzle head 302, is attached to a male component, a rotatable nozzle shaft 304, that is free to rotate in a nozzle body 306. The nozzle body 306 is, in turn, connected to a high pressure fluid hose (not shown). The male component, rotatable nozzle shaft 304, has external threads 308 adjacent its distal end 310 and an annular groove 312 in the shaft 304 rearward of the threads 308. The nozzle head 302 has an internally threaded central blind bore 314 and a plurality of offset fluid passages 316 out of the nozzle head 302 to, at least in part, impart rotation to the shaft 304 in operation as in the embodiment 200 just described.

The nozzle head 302 has an annular groove 318 adjacent its rear end as in embodiment 200 spaced from the internal threads. When the shaft and head are fully threaded together, annular grooves 312 and 318 are axially and radially aligned. Instead of an annular wire ring 222 placed in the aligned grooves 312 and 318, a roll pin 320 is inserted into an offset cross bore 322 drilled through the head 302 that intersects the groove 318. This roll pin 320 engages the sides of the groove 312 to prevent unthreading of the head 302 from the male component 304 thus locking the mated components 304 and 302 together. To assemble the apparatus 300, the nozzle head 302 is threaded onto the shaft 304 until the distal end 310 of the shaft 304 is fully seated in the blind bore 314. At this point, the grooves 312 and 318 will be axially and radially aligned. Then the roll pin 320 is pressed into the offset cross bore 322. This roll pin 320 acts to prevent separation of the components 302 and 304 beyond the width of the aligned grooves 312 and 318.

During operation, should a reverse torque somehow be applied to the threaded connection, in this case between the nozzle head 302 and shaft 304, sufficient to disengage shaft distal end 310 from its seat within the blind bore 314, the head 302 could rotate via threads 308, a short distance, until the edges of grooves 312 and 318 engage the roll pin 320. Further rotation is prevented thus locking the head 302 and 304 together. If this event should happen, there may be some fluid leakage past the threads 308 such that an operator of the tool may notice an unusual leak rate, or if depressurized, he may notice the loose head 302 on the shaft 304. In this embodiment, the roll pin 320 must be pressed out of the offset bore 322 in order to completely remove the head 302 from the shaft 304.

Another exemplary embodiment of a locking apparatus 400 in accordance with the present disclosure is shown in FIG. 10. The locking apparatus 400 includes a female component, in this case a nozzle head 402 is attached to a male component, again a rotatable nozzle shaft 404, that is free to rotate in a nozzle body 406. The nozzle body 406 is, in turn, connected to a high pressure fluid hose (not shown). The male component, rotatable nozzle shaft 404, has external threads 408 adjacent its distal end 410 and has an annular groove 412 in the shaft 404 rearward of the threads 408. The nozzle head 402 has an internally threaded central blind bore 414 and a plurality of offset fluid passages 416 out of the nozzle head 402 to, at least in part; impart rotation to the shaft 404 in operation. The nozzle head 402 has an annular groove 418 adjacent a rear end of the nozzle head 402. The nozzle head 402 has a lateral rear portion 420 cut away to expose part of the groove 418, and part of the groove 412 in the shaft 404 when the head 402 and shaft 404 are fully mated. A C-clip retaining member 422 is radially pressed into the mated grooves 418 and 412 so as to snap around the shaft 404 to complete the assembly of apparatus 400.

In order to disassemble the locking assembly 400 first the retaining member 422 is laterally pried out of the groove 412 and off of the shaft 404. Then the head 402 may be unthreaded from the shaft 404. Again, should the head 402 become loosened during nozzle operation, there will likely be some fluid leakage past the threads 408 providing an indication to an operator that the head 402 has become loose, with the retaining member 422 preventing full separation of the head 402 from the shaft 404.

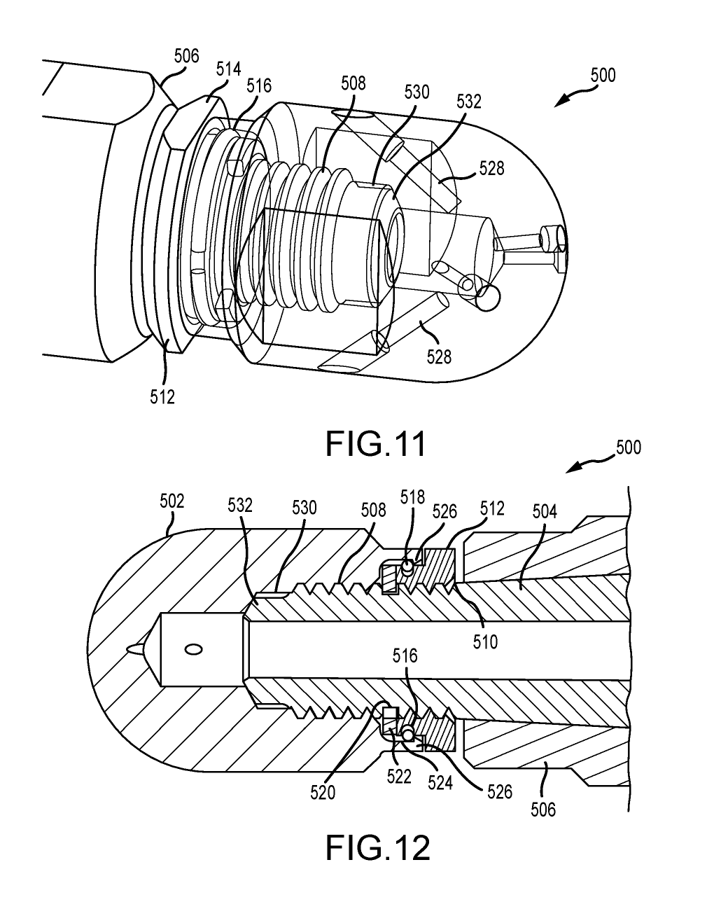

A still further embodiment in accordance with the present disclosure is shown in FIGS. 11 and 12. A partial perspective view of locking apparatus 500 is shown in FIG. 11 and a longitudinal sectional view of the locking apparatus 500 is shown in FIG. 12.

This embodiment involves use of both a C-clip retainer as in the apparatus 400 and a wire spring clip ring as used in the apparatus 200 described above along with a threaded retaining ring 512. In this exemplary embodiment, again the female component is a nozzle head 502 which is threadably attached to a rotatable shaft 504 carried in a nozzle housing 506. The external threads 508 on the shaft 504 extend further along the shaft 504 than in the embodiments 100 through 400 described above to a shoulder 510 on the shaft 504, in order to receive a threaded ring 512 that is first installed on the shaft 504. This threaded ring 512 abuts against the shoulder 510 and may include external wrench flats 514. The threaded ring 512 has an external annular groove 516 therearound to receive an annular retaining spring ring member 518 therein. The shaft 504 also has an annular groove 520 spaced from the shoulder 510 at the rear threaded end of the shaft 504. This annular groove 520 receives a C-clip retainer ring 522.

The internally threaded female component, nozzle head 502, has an annular internal groove 524 formed at its rear end beyond the internal threads that engage threads 508 on the male member, shaft 504. This groove 524 defines a rear lip 526 at the rear end of the head 502. The groove 524 is sized with a width so as to accommodate passage of the C-clip retainer ring 522 and a portion of the threaded ring 512 containing the annular groove 516 with the annular retaining spring ring member 518 therein as can be seen best in the sectional view of FIG. 12.

As in the prior described and illustrated embodiments, the nozzle head 502 has a plurality of ports 528 that lead from a central threaded blind bore 530 to the exterior of the nozzle head 502. The distal end 532 of the shaft 504 is designed to abut against the blind bore 530 so that fluid within the central passage through the shaft 504 flows out the ports 528.

Assembly of the apparatus 500 begins with threading the threaded ring 512 onto the shaft 504 past the groove 520 to the shoulder 510 on the shaft 504. A wire spring retainer ring 518 is then installed in the groove 514 on the threaded ring 512. Alternatively the retainer ring 518 may first be installed on the threaded ring 512 prior to installation of the threaded ring 512 on the shaft 504. A C-clip retainer ring 522 is then laterally installed around the shaft 504 in the groove 520. This retainer ring 522 prevents the threaded ring 512 from unscrewing past the groove 520.

Next the nozzle head 502 is threaded onto the shaft 504 until rear lip 526 passes over the C-clip retaining ring 522 and over the wire spring retainer ring 518 in the groove 516 in the threaded ring 512. The head 502 and 504 are then tightened to seat the distal end 532 of the shaft 504 in the head 502. In this configuration the lip 526 will be beyond the wire spring retainer ring 518.

During device operation, should the head 502 become loosened on the shaft 504, again there will likely be some leakage past the threads 508, giving an operator an indication of this loosened condition. Furthermore, the lip 526 will engage the wire ring retainer 518 to prevent further loosening of the head 502 from the shaft 504, hence providing the lock. Substantial additional torque must be exerted between the components 502 and 504 in the apparatus 500 to compress the wire spring clip 518 within the groove 516 in the threaded ring 512. Again, the back angle of the lip 526 will determine the amount of excess torque required between the shaft and head to disengage the female component from the male component.

Many variations are envisioned as within the scope of the present disclosure. For example, the wire retainer ring 222 could be utilized in place of the canted coil spring 124 in the first embodiment 100 described above.

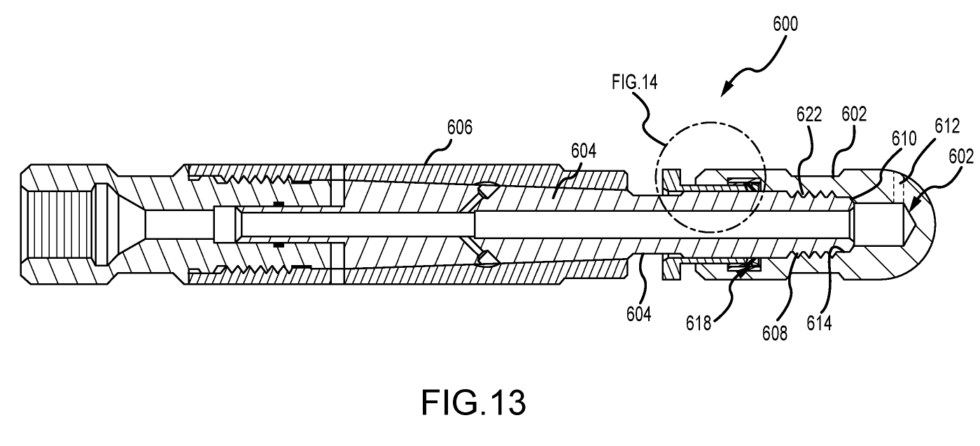

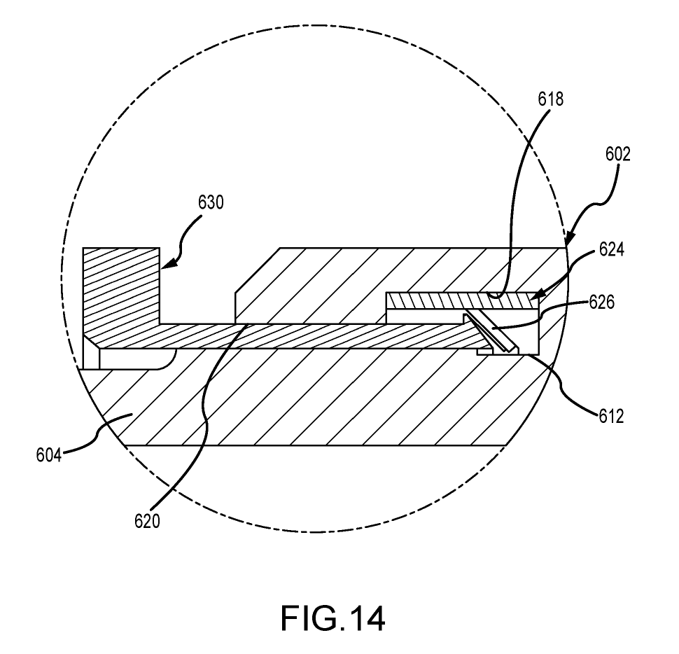

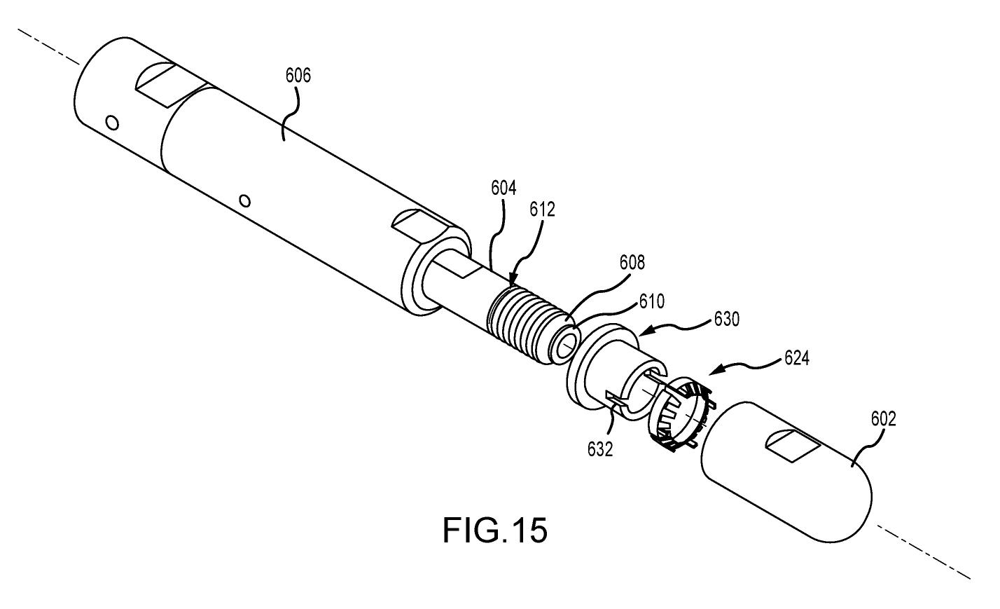

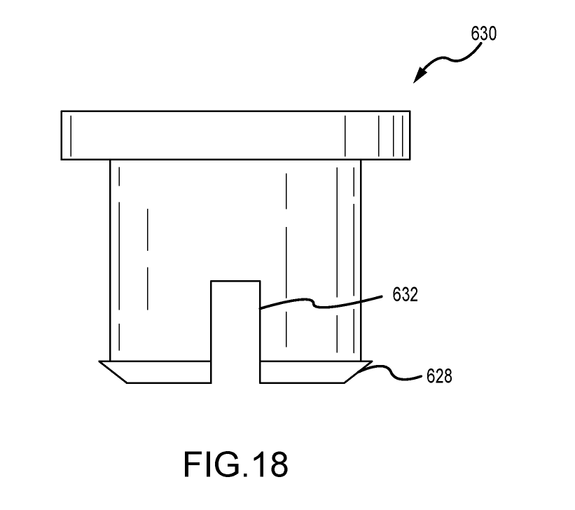

Another embodiment of a locking apparatus in accordance with the present disclosure is illustrated in FIGS. 13 through 18. FIG. 13 is a longitudinal sectional view of a high pressure rotary nozzle 600 incorporating a threaded component locking apparatus 650 in accordance with the present disclosure. Apparatus 650 comprises a release plunger 630 (either a single sleeve body or separate C shaped segments) and a locking spring clip member 624 that interacts with features formed in the nozzle components described below. The threaded components, for use with this embodiment 650, are a nozzle head 602, and a rotatable tubular nozzle shaft 604, that is free to rotate in a nozzle body 606. The nozzle body 606 is, in turn, connected to a high pressure fluid hose (not shown). The male component, rotatable tubular nozzle shaft 604, has external threads 608 adjacent its distal end 610 and an annular groove 612 in the shaft 604 rearward of the threads 608. The nozzle head 602 has an internally threaded central blind bore 614 and a plurality of offset fluid passages 616 leading from the bore 614 out of the nozzle head 602 to, in part, impart rotation to the shaft 604 in operation.

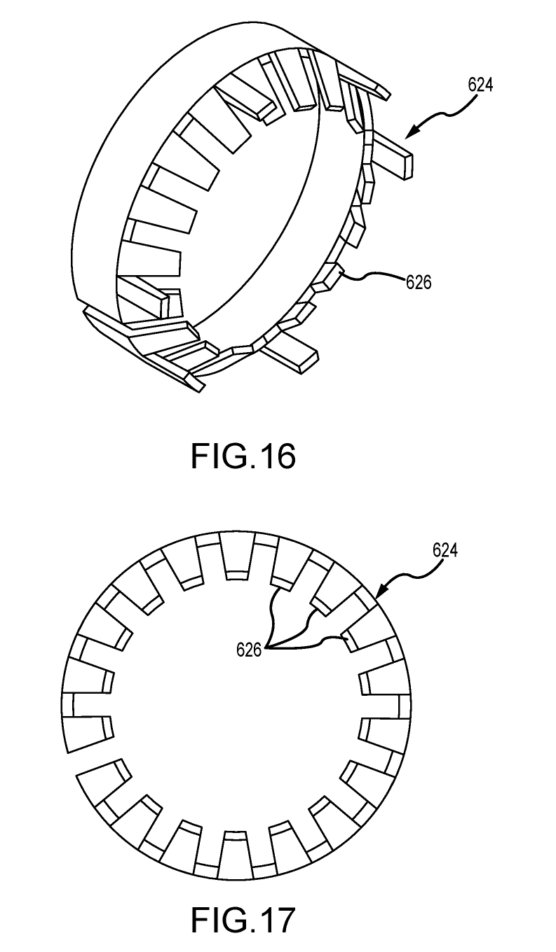

The nozzle head 602 has an annular groove 618 spaced from its rear end forming part of an annular rear skirt portion 620 spaced from internal threads 622 that mate with external threads 608 on the shaft 604. The annular groove 618 is formed in this skirt portion 620. When the shaft 604 and head 602 are fully threaded together, annular grooves 612 and 618 are radially aligned. A lock spring clip 624 placed in the aligned grooves 612 and 618 locks the mated components 604 and 602 together. This spring clip member 624 is separately shown in FIGS. 16 and 17. This spring clip member 624 is preferably a tempered spring steel band formed into a tempered ring with a gap between its ends so that it can be elastically compressed to reduce its diameter so as to fit within the blind bore 614 and then expand into the groove 618 in the skirt portion 620 of the head 602. The ring shaped spring clip 624 has a plurality of spaced bent tines 626 that extend inward toward the center of the clip and intermixed with a plurality of straight tines 627 that engage a front end of the groove 618 in the head 602. The straight tines 627 ensure that the spring clip 624 is properly positioned or seated within the groove 618.

To assemble the nozzle 600, which utilizes a two piece plunger 630 in one embodiment of the assembly 650, the spring clip 624 is installed within the groove 618 in the head 602. Then the shaft 604 is inserted into the head 602 past the spring clip 624 so as to threadably mate with the threads 622. The nozzle head 602 is then threaded onto the shaft 604 until the distal end 610 of the shaft 604 is fully seated in the blind bore 614 as is shown in FIG. 13. As the distal end 610 passes the groove 618, the tines 626 on the spring clip 624 in groove 618 deflect to permit shaft 604 to pass. When the distal end 610 of the shaft 604 is fully seated as shown, the grooves 612 and 618 are aligned, and the tines 626 of the clip ring 624 snap back, i.e., are partially expanded into the complementary groove 612 around the shaft 604. A short further rotation of the shaft 604 causes the distal end 610 to engage the end of the blind bore 614 to form a water tight seal between the head 602 and the shaft 604.

During operation, should a reverse torque somehow be applied to the threaded connection, in this case between the nozzle head 602 and shaft 604, sufficient to disengage shaft distal end 610 from its seat in the blind bore 614, the head 602 could conceivably rotate via threads 608/622 a short distance until the tines 626 on the spring clip 624 engage and wedge against the distal end of the groove 612. The head 602 is thus stopped or locked from being further loosened. If this event should happen, there will no longer be a seal formed by the distal end 610 in the bore 614 and there will likely be some fluid leakage past the threads 608/622 such that an operator of the tool may notice an unusual leak rate, or if depressurized, he may notice the loose head 602 on the shaft 604.

In order to properly remove the head 602 from the shaft 604, in this case, the two piece sleeve shaped release plunger 630 must be inserted between the mated head 602 and shaft 604 via the annular gap between the rear annular portion 620 of the head 602 and the shaft 604 and pushed forward under the clip 624 so as to lift the tines 626 out of the groove 612 in the shaft 604. Then the head 602 may be unthreaded from the shaft 604.

In the above mentioned alternative embodiment of nozzle 600 in which the plunger 630 is a separate two piece structure that is not initially installed, if the head 602 somehow becomes loose on the shaft 604, a significant further torque will be required to unlock the head 602, i.e., cause the tines 626 to deform enough to permit the head 602 to be unthreaded enough to pass by the spring clip 624 and completely remove the head 602 from the shaft 604. As the tines 626 of the spring clip 624 are preferably made of a strong tempered spring steel, forced attempts at removal could result in essentially a mechanically stuck/locked head 602 on the shaft 604 that would have to be completely replaced to solve potential excessive leakage.

This release plunger 630 is preferably a one piece tubular sleeve shaped part of the initial assembly of the nozzle 600, as is shown in FIGS. 13, 14 and 18, rather than a two piece design. The release plunger 630 has an annular barb-like protrusion 628 at its distal end. In order for the plunger 630 to deflect during installation enough to pass through blind bore 614 to the groove 618, a pair of axially extending relief slots 632 is formed in its distal end. The reason for preferably utilizing a one piece plunger 630 is primarily that this assembly 650 will be readily apparent to one looking at the assembled nozzle 600, as compared to a nozzle that does not incorporate the assembly 650. The plunger 630 becomes a clearly visible component behind the head 602 to distinguish the nozzle 600 that includes an assembly 650 from one that does not include a secondary locking device. In the case of the first embodiment of the assembled nozzle 600 described first above, without the one piece plunger 630, there is really nothing to clearly indicate to a user that the nozzle 600 incorporates a spring clip 624 inside. Hence use of a one piece tubular plunger 630 is preferred.

To assemble the nozzle 600 incorporating the plunger 630 along with the spring clip 624, the spring clip 624 is first installed within the annular groove 618 within the head 602. This spring clip 624 can be squeezed to close the gap between the ends of the clip in order to fit within the head 602. When the spring clip 624 is fully within the groove 618, the clip snaps outward to its released diameter to retain the clip 624 in the groove 618. Next the release plunger 630 is installed within the head 602 such that the annular protrusion 628 engages the rear edge of the groove 618. The head 602 is then installed on the shaft 604 and the distal end 610 pushed past the tines 626 of the spring clip 624 residing in the groove 618 and the threads 608 adjacent the distal end 610 finally threaded into the internal threads 622 adjacent the end of the blind bore 614 to fully seat the head 602 on the shaft 604.

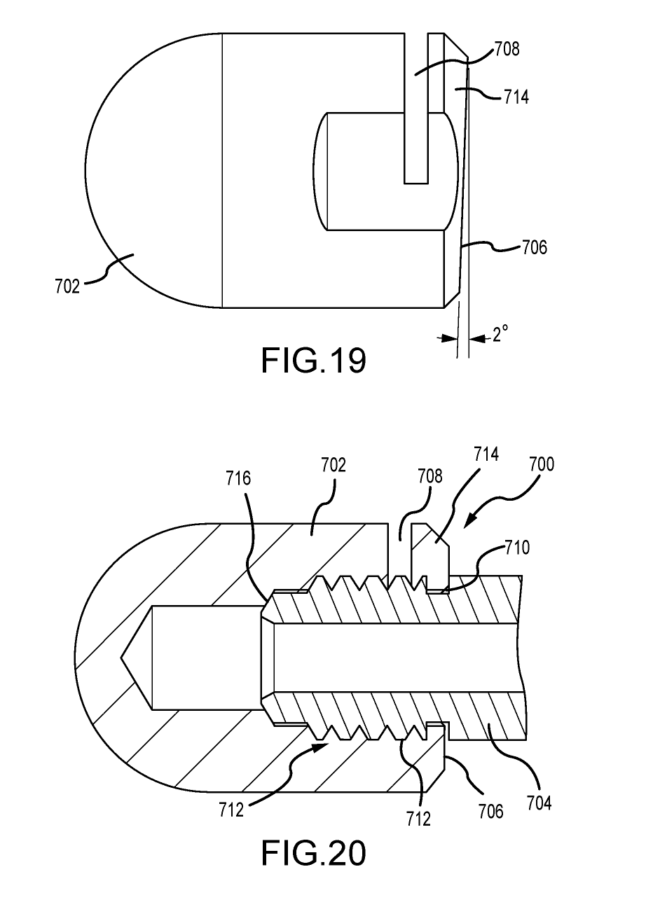

Another threaded component locking apparatus 700 in accordance with the present disclosure is shown in FIGS. 19 and 20. One embodiment of this apparatus 700 is implemented in a high pressure nozzle application to lock a nozzle head 702 to a male threaded hollow shaft 704, but may also be utilized on any threaded connection between two components. The rear end face 706 of the female component, in this case head 702 is angled at a small angle from a plane normal to the axis of the head 702. In the exemplary embodiment shown, this angle is about 2 degrees. A radial slot 708 is sliced normal to the nozzle head 702 spaced one or two thread widths from the rear end face 706 forming a cantilevered threaded portion 714. This radial slot 708 preferably has a depth between about ½ to ⅝ the diameter of the head 702. The small angle cant of about 2 degrees is measured from a plane normal to the central axis of the head 702 and the radial slot 708.

The male threaded hollow shaft 704 has a radial shoulder 710 spaced behind the threads 712. When the head 702 and shaft 704 are threaded together, and the rear end face 706 torqued against the shoulder 710 on the side of the head 702 first contacted, the cantilevered portion 714 of the head 702 between the rear end face 706 and shoulder 710 pinches against the mating threads within the slot 708 to lock the shaft 704 to the head 702. A slight further movement of the shaft 704 into the head 702 engages the end of shaft 704 with the head 702 to form a conventional pressure seal interface 716 between the shaft 704 and head 702.

During nozzle operation, if sufficient reverse torque were to be applied to the threaded connection to initially loosen the threads 712 from the interface 716, the cantilevered portion 714 would remain engaged with the threads 712. Such loosening would most likely be signified by leakage past the interface 716, while the engagement of the threads 712 remain locked together. If the head 702 loosens enough such that the head end face 706 and shaft shoulder 710 are no longer in contact, the cantilevered portion 714 would no longer pinch the threads 712 thus allowing removal of the head 702 from the shaft 704.

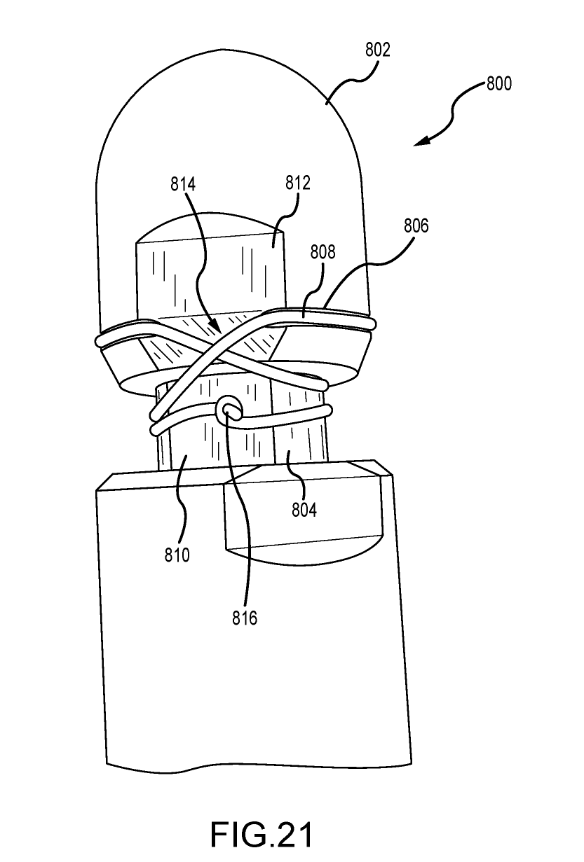

Another embodiment of a threaded component locking apparatus in accordance with the present disclosure is shown in FIG. 21 applied to a high pressure rotary nozzle 800. In this embodiment 800, the female nozzle head 802 is threaded onto the rotary nozzle shaft 804 in a conventional manner. The head 802 has a peripheral annular groove 806 adjacent its rear end to receive a lock wire 808. This lock wire 808 is wrapped in the groove 806 around the head 802 and around the shaft 804 preferably at least twice and stretched tight over the wrench flats 810 on the shaft 804. The head 802 has two opposing wrench flats 812 and the lock wire 808 is crisscrossed in a recess 814 formed in and adjacent to one of the wrench flats 812 so that the lock wire 808 remains recessed within the outer profile of the nozzle 800. The opposite ends 816 of the lock wire 808 are twisted tightly together adjacent the one of the flats 810 on the shaft 804 and sheared. Alternatively the twisted ends 816 may be tack welded together before shearing off the excess wire. This lock wire 808 must be of sufficient gage that the bends formed at the edges of the flats withstand any anticipated torque during operation. Although only one wrap of the wire 808 around the shaft 804 is shown, additional turns may be utilized to add further resistance to unscrewing torque.

During operation of the nozzle 800, should the head 802 become loosened from the shaft 804, the resistance provided by the lock wire passing tightly over the flats 810 initially prevents the head 802 from becoming further loosened on the threaded shaft 804. In addition, because the shaft 804 at the location of the flats 810 has a smaller outside diameter than the threaded portion of the shaft 804, further loosening is prevented by the interference between the turns of the lock wire 808 on the shaft 804 and those threads.

While the disclosure above has been illustrated as involving connection of a high pressure nozzle body to a nozzle head, there are many other situations in which one of the embodiments of the threaded component locking apparatus may also be utilized. The embodiments of the locking apparatus may be utilized in any threaded connection where a male threaded component is fastened to a female threaded component. For example, a different tool than a nozzle head may be attached to a male threaded hose end connection. In such an application, the locking apparatus prevents full disengagement of the tool from the hose end. Embodiments of the threaded component locking apparatus according to the present disclosure may also be used to join two lengths of hoses, again to prevent inadvertent disconnection of one hose from the other. Therefore, all such changes, alternatives and equivalents in accordance with the features and benefits described herein, are within the scope of the present disclosure. Such changes and alternatives may be introduced without departing from the spirit and broad scope of this disclosure as defined by the claims below and their equivalents.

What is claimed is:

1. A locking apparatus for use between a female threaded component having parallel external wrench flats and a male threaded component having parallel external wrench flats, the apparatus comprising:
a pair of split annular collar halves each half having an outer flange portion having at least two parallel external wrench flats, an annular outer groove portion, and two parallel internal flats radially spaced from the external wrench flats complementary to wrench flats of a male threaded component such that the internal flats fit over and against the male threaded component wrench flats when the pair of halves are mated on the male threaded component; and
an annular spring member sized to elastically fit into the outer groove portions of the split collar halves when the pair of halves are installed onto and over the wrench flats of the male threaded component.

2. The apparatus according to claim 1 further comprising the female threaded component having a skirt portion and an internal annular groove within the skirt portion for receiving an outer portion of the annular spring member.

3. The apparatus according to claim 1 wherein the annular spring member is an annular canted coil spring.

4. The apparatus according to claim 3 further comprising the female threaded component having a skirt portion and an internal annular groove within the skirt portion for receiving an outer portion of the canted coil spring.

5. The apparatus according to claim 2 wherein one end of the skirt has an internal annular ridge adjacent the groove.

6. The apparatus according to claim 4 wherein the canted spring has a plurality of spaced outwardly projecting canted portions for engaging a portion of the skirt defining the groove when the threaded male component is threaded into the female component.

7. The apparatus according to claim 3 wherein the canted spring member has a plurality of spaced inwardly canted portions for engaging the annular outer groove portions of the collar halves when the halves are mated on the male component.

8. The apparatus according to claim 6 wherein the canted spring member has a plurality of spaced inwardly canted portions for engaging the annular outer groove portions of the collar halves when the halves are mated on the male component and wherein the inwardly canted portions and outwardly canted portions are partial coils of the coil spring.

9. The apparatus according to claim 8 wherein the annular canted coil spring is oriented on the mated annular collar halves such that relative rotation of the mated male and female threaded components in a tightening direction increases cant of the canted coil spring.

10. The apparatus according to claim 2 wherein the annular spring member is oriented on the mated annular collar halves such that relative rotation of the mated male and female threaded components in a tightening direction increases deflection of the annular spring member.

11. The apparatus according to claim 10 wherein the female threaded component is a rotary fluid nozzle head and the male threaded component is a fluid nozzle shaft.

12. A nozzle assembly comprising:
a hollow cylindrical housing body having an inner surface, an inlet end, an outlet end, and a fluid inlet passage near the inlet end,
a hollow shaft rotatably mounted coaxially within the housing body having a fluid inlet end near the inlet end of the housing body and an outlet end of the hollow shaft member extending out of the body having external male threads and a pair of parallel wrench flats; said shaft having a central passage for axially conducting fluid from said inlet end of the housing axially from and through the inlet end of the shaft to said outlet end of the shaft, and having a passage communicating between the central passage of the shaft and a pressure chamber, wherein pressure of the fluid within the pressure chamber at least in part acts axially upon said shaft to dynamically balance any axial force on said shaft resulting from fluid pressure acting upon said inlet end of said shaft;
a spray head attached to the outlet end of the hollow shaft member, the spray head having parallel external wrench flats and a female threaded portion;
a locking apparatus between the spray head and the hollow shaft member operable to resist relative rotation of the spray head with respect to the hollow shaft in a loosening direction.

13. The nozzle assembly according to claim 12 wherein the locking apparatus comprises;
a pair of split annular collar halves each half having an outer flange portion having at least two parallel external wrench flats, an annular outer groove portion, and two parallel internal flats radially spaced from the external wrench flats complementary to the wrench flats of the hollow shaft member outlet end, the internal flats fitting over and against the hollow shaft member outlet wrench flats; and
an annular spring member in the outer groove portions of the split collar halves installed onto and over the wrench flats of the hollow shaft member.

14. The nozzle assembly according to claim 13 further comprising the nozzle head having a skirt portion and an internal annular groove within the skirt portion for receiving an outer portion of the annular spring member.

15. The nozzle assembly according to claim 13 wherein the annular spring member is an annular canted coil spring.

16. The nozzle assembly according to claim 15 further comprising the nozzle head having a skirt portion and an internal annular groove within the skirt portion for receiving an outer portion of the canted coil spring.

17. The nozzle assembly according to claim 14 wherein one end of the skirt has an internal annular ridge adjacent the groove.

18. The nozzle assembly according to claim 16 wherein the canted spring has a plurality of spaced outwardly projecting canted portions for engaging a portion of the skirt defining the groove when the nozzle head is fastened to the hollow shaft.

19. The nozzle assembly according to claim 15 wherein the canted spring member has a plurality of spaced inwardly canted portions for engaging the annular outer groove portions of the collar halves when the halves are mated on the hollow shaft member outlet end.

20. The nozzle assembly according to claim 16 wherein the canted spring member has a plurality of spaced inwardly canted portions for engaging the annular outer groove portions of the collar halves when the halves are mated on the hollow shaft member outlet end and wherein the inwardly canted portions and outwardly canted portions are partial coils of the coil spring.

21. The nozzle assembly according to claim 16 wherein the annular canted coil spring is oriented on the mated annular collar halves such that relative rotation of the mated male and female threaded components in a tightening direction increases cant of the canted coil spring.

22. The nozzle assembly according to claim 13 wherein the annular spring member is oriented on the mated annular collar halves such that relative rotation of the mated threaded nozzle head and shaft member in a tightening direction increases deflection of the annular spring member.

23. The nozzle assembly according to claim 12 wherein the spray head has a rear end skirt portion adjacent the female threaded portion and the locking apparatus comprises:
an annular internal groove in the skirt portion;
a split annular spring clip within the internal groove; and
an external groove around the hollow shaft member between the wrench flats on the shaft member and the male threads, wherein the external groove radially aligns with the internal groove in the skirt portion and tines on the spring clip engage the hollow shaft in the external groove.

24. The nozzle assembly according to claim 23 wherein the tines are bent radially inwardly to grip the shaft member in the external groove.

25. The nozzle assembly according to claim 23 wherein the spring clip includes a plurality of straight tines to orient the spring clip in the internal groove in the skirt portion of the head.

26. The nozzle assembly according to claim 23 further comprising a release plunger adapted to fit between the shaft member and the skirt portion operable to release the tines from the external groove to permit disassembly of the head from the shaft.

27. The nozzle assembly according to claim 26 wherein the release plunger has a tubular sleeve shape.

28. The nozzle assembly according to claim 27 wherein the release plunger has a protrusion at its distal end for deflecting the tines of the spring clip.

29. The nozzle assembly according to claim 12 wherein the locking apparatus comprises a rear end face of the nozzle head being angularly offset and a rear portion of the nozzle head having a transverse normal slot spaced from the rear face forming a cantilever portion adjacent the rear face, and the hollow shaft having a shoulder formed adjacent the male threads, whereby when the hollow shaft is fully tightened to the nozzle head, the cantilever portion engages the shoulder to pinch against mating threads within the head.

30. The nozzle assembly according to claim 12 wherein the locking apparatus comprises a lock wire wrapped in a peripheral external grove around a rear portion of the head and crisscrossed over one of the wrench flats in the head, the lock wire being wrapped at least once fully around and over the wrench flats on the hollow shaft.

31. The nozzle assembly according to claim 30 wherein the lock wire has ends twisted together adjacent one of the wrench flats in the hollow shaft.

32. The nozzle assembly according to claim 30 wherein the peripheral external groove around the rear portion of the head extends over a portion of one of the wrench flats of the head to accommodate the crisscrossed lock wire.

33. A locking apparatus for use on a threaded connection between a female threaded component having a rear end and a male threaded component having a distal end, the apparatus comprising:
an external annular groove in and around the male threaded component spaced from threads on the male threaded component;
an internal annular groove in the female threaded component adjacent a rear end of the female threaded component, the rear end forming an inwardly directed lip; and
a spring member disposed within the external annular groove having a portion extending outward into the internal annular groove of the female threaded component when the distal end of the male threaded component is fully inserted into the female threaded component;
wherein the spring member engages the lip to prevent unintentional disconnection of the male and female threaded components.

34. The apparatus according to claim 33 wherein the spring member is a wire spring ring.

35. The apparatus according to claim 33 wherein the spring member expands within the internal annular groove when the internal and external annular grooves are aligned.

36. The apparatus according to claim 35 wherein the spring member is a wire spring clip ring.

37. A locking apparatus for use on a threaded connection between a female threaded component having a rear end and a male threaded component having a distal end, the apparatus comprising:
an external annular groove in and around the male threaded component spaced from external threads on the male threaded component;
an internal annular groove in the female threaded component adjacent a rear end of the female threaded component forming an inwardly directed lip at the rear end;
a C-clip retainer ring disposed within the external annular groove having a portion extending outward into the internal annular groove;
wherein the C-clip retainer ring prevents unintentional disconnection of the male and female threaded components.

38. The apparatus according to claim 37 wherein the female component has a portion at its rear end cut way exposing the internal annular groove.

39. The apparatus according to claim 38 wherein the C-clip retainer ring is laterally inserted and withdrawn to install and remove respectively the C-clip retainer ring from the external annular groove around the male component.

40. A locking apparatus for use on a threaded connection between a female threaded component having a rear end and a male threaded component having a distal end, the apparatus comprising:
an external annular groove in the male threaded component spaced from threads on the male threaded component;
an internal annular groove in the female threaded component adjacent a rear end of the female threaded component;
an offset cross bore through the female component into the internal annular groove; and
a roll pin pressed within the cross bore having a portion extending at least partially into the external annular groove, wherein the portion in the external annular groove in the male threaded component engages the male threaded component thereby locking the male and female threaded components together.

41. The apparatus according to claim 40 wherein the roll pin pressed within the cross bore extends into and beyond the external annular groove.

42. The apparatus according to claim 40 wherein the internal annular groove in the female threaded component define
